(19) United States
(12) Patent Application Publication
(10) Pub. No.: US 2007/0016456 A1
(43) Pub. Date: Jan. 18, 2007

(54) System, method and program product for reporting status of contract performance or a process

(75) Inventors: Kevin David Himberger, Durham, NC (US); Clark Debs Jeffries, Chapel Hill, NC (US); Allen Leonid Roginsky, Durham, NC (US); Charles Steven Lingafelt, Durham, NC (US); Phillip Singleton, Raleigh, NC (US)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 11/179,429

(22) Filed: Jul. 12, 2005

(51) Int. Cl. G06F 9/44

(52) U.S. Cl. 705/7

(57) ABSTRACT

System, method and program product for reporting status of a process. A flow chart illustrates steps of the process and an order for performance of the steps. Then, a determination is made whether any of the steps has been performed. In response to a determination that any of the steps has been performed, graphically representing on the flow chart that the step has been performed. The graphical representation can be color-coding of the step. The determination that a step has been performed can be made based on user input that the step has been performed, or automatically by a program checking a record indicating that the step has been performed. Also, a program can automatically determine that a deadline for performing one of the steps has passed without performance of the one step. In response, the program initiates a graphical representation on the one step in the flowchart that the deadline has passed without performance of the one step. A program can also automatically determine that a problem has occurred in performing one of the steps, and in response, graphically represent on the one step in the flowchart that a problem has occurred with the one step.

### BACKGROUND

The invention relates generally to reporting of status of contract performance or a process, and more particularly to a semi-automated technique to report such status using a computer.

It is common for individuals and businesses to enter into contracts, and for the contracts to have steps or sequential tasks of completion. These steps or tasks may be specified in the contract or inherent to the type of product or service requested in the contract. Often the customer will inquire as to the status of contract performance, and the vendor/supplier/manufacturer will either call the customer to report the status or send a written status report via a letter or e-mail. For example, in a construction contract, a vendor may report that the foundation has been laid, but no framing has yet begun. In a computer services contract, a vendor may report that certain software has been installed, but not yet tested.

There are also a wide variety of manufacturing, service and business processes that are performed in steps or sequential tasks. For example, in the field of computer support services, a vendor detects a problem with a customer system, then gathers preliminary information about the problem, then notifies the customer of the problem, then gathers more detailed information about the problem, then attempts to fix the problem, and then fixes the problem. When learning of a problem, the customer may repeatedly request current status information regarding the fix. The vendor will either call the customer to report the status or send a written status report via a letter or e-mail.

While the foregoing techniques are effective to report the status to the customer, they require a status request from the customer and a telephone call, letter or e-mail from the vendor. All these activities take time. Also, for a large contract or complicated process, there may be many people in the customer organization that need status information, and this may result in multiple status requests. Also, many of the people in the customer organization may not know who to call in the vendor organization for the status. Also, there may be considerable time lapse between the time that a step is completed, and when the customer requests status information and learns of the new status.

Accordingly, an object of the present invention is to improve the manner of presenting and reporting status of contract performance, a manufacturing process, a service process, a business process or another type of process.

### SUMMARY OF THE INVENTION

The present invention resides in a system, method and program product for reporting status of a process. A flow chart illustrates steps of the process and an order for performance of the steps. Then, a determination is made whether any of the steps has been performed. In response to a determination that any of the steps has been performed, graphically representing on the flow chart that the step has been performed.

In accordance with features of the present invention, the determination that a step has been performed can be made based on user input that the step has been performed, or automatically by a program checking a record indicating that the step has been performed.

In accordance with other features of the present invention, a program can automatically determine that a deadline for performing one of the steps has passed without performance of the one step. In response, the program initiates a graphically representation on the one step in the flowchart that the deadline has passed without performance of the one step. A program can also automatically determine that a problem has occurred in performing one of the steps, and in response, graphically represent on the one step in the flowchart that a problem has occurred with the one step.

The graphical representation can be color-coding of the step.

### BRIEF DESCRIPTION OF THE FIGURES

FIG. 1 is a block diagram of a distributed computer system in which the present invention is incorporated.

FIG. 2 illustrates a method by which a vendor creates a flow chart representing steps or tasks of contract performance or a manufacturing, service or business process.

FIG. 3 is an example of a flow chart created by the method of FIG. 2.

FIG. 4 is a flow chart of a status reporting program within the computer system of FIG. 1 to cause a graphical display, on the flow chart of FIG. 2, of the status of contract performance, or a manufacturing, service or business process, according to the present invention.

### DETAILED DESCRIPTION OF THE PREFERRED EMBODIMENTS

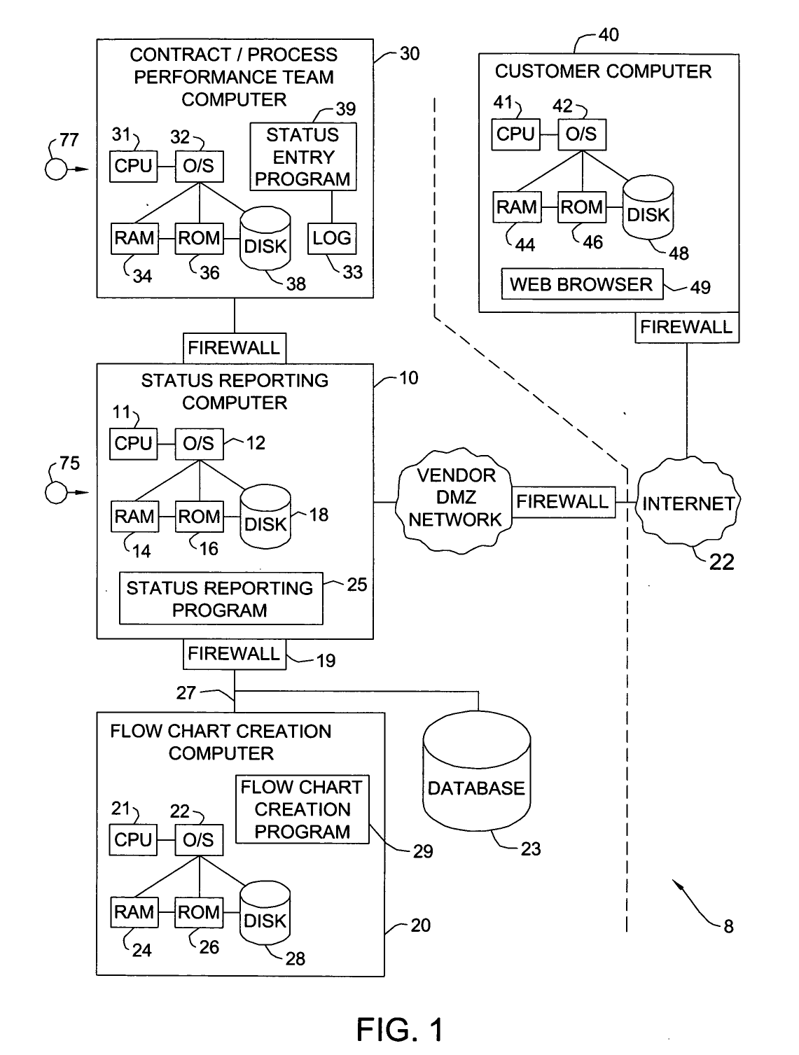

The present invention will now be described in detail with reference to the figures. FIG. 1 illustrates a distributed computer system generally designated 8 which incorporates the present invention. Distributed computer system 8 comprises a vendor computer 10 with a standard/known CPU 11, operating system 12, RAM 14, ROM 16, and disk storage 18. Distributed computer system 8 also includes a flowchart generation computer 20 with a standard/known CPU 21, operating system 22, RAM 24, ROM 26, and disk storage 28. Flowchart generation computer 20 also includes a flowchart generation program tool 29 to generate a flow chart representing steps or sequential tasks of contract performance or a manufacturing, service or business process to be performed. Known program tool 29 also generates a graphical image to represent the flow chart, so that the flow chart can be sent over the Internet 22 and viewed by a web browser 48 of a customer computer 40. In the illustrated embodiment, the program tool 29 resides in a computer 20 separate from computer 10 and generates the flowchart based on templates stored in storage 23 and vendor input. Computer 10 can access the resultant flow chart via a network 27 and a firewall 19. However, if desired, program tool 29 could also reside directly on vendor computer 10. In accordance with the present invention, vendor computer 10 also includes a status reporting program 25 to cause graphical display, on the flow chart, of the status of each of the steps or sequential tasks of the flowchart. Such graphical display can comprise color coding of the steps of the flow chart with green, yellow or red as described below.

Distributed computer system 8 also includes a computer workstation 30 where a worker performing the contract or process can enter data which directly or indirectly indicates status of contract performance or the steps of the process. A status entry portion 39 within workstation 30 enters a record in a log or file 33 which indicates completion of steps. Computer workstation 30 also includes a known/standard CPU 31, operating system 32, RAM 34, ROM 36 and storage 38.

Distributed computer system 8 also includes a customer computer 40 coupled to the vendor computer 11 via the Internet 22, shared network, extranet link, or other network. The customer computer 40 also includes a known/standard CPU 41, operating system 42, RAM 44, ROM 46, storage 47, and a web browser 48 to display the flow chart with the graphical status of its steps, as generated by the vendor computer 11.

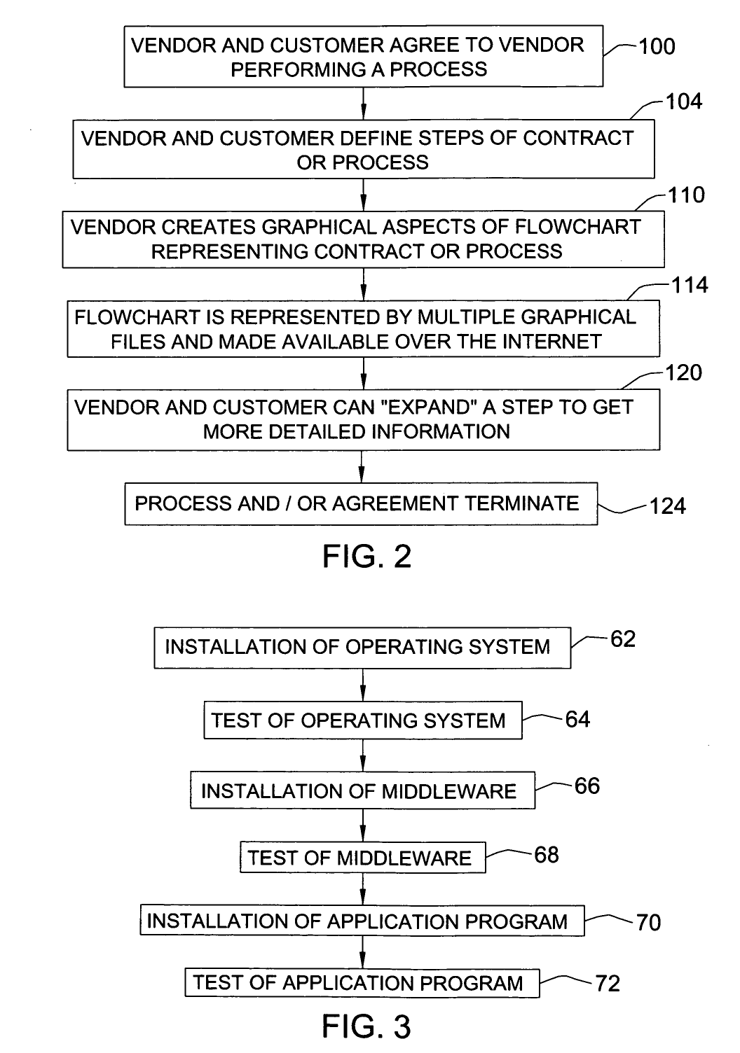

FIG. 2 illustrates the process of creating a flow chart representing the steps or sequential tasks of contract performance or a manufacturing, service or business process. Initially, a vendor (person) identifies to the flowchart generation program 29 a contract, a manufacturing process, a business process, or a service process to be performed (step 100). Then the vendor, typically with input from the customer, defines to the flowchart generation program 29 a series of steps or sequential tasks of contract performance or the process (step 104). In step 104, the vendor enters information for the parameters listed in the following Flowchart table template (with the exception of state information):

### Flowchart Table Parameters and Fields

“Flowchart ID”—a “primary key” identifier/integer for the flowchart (which is unique among all flowcharts).
“Flowchart name”—another identifier, in the form of a human understandable name, for the flowchart.
“State”—the current status of the flowchart represented by a value for the specified integer. For example, the state can be “not yet begun”, “currently in progress, and on schedule”, “currently in progress, but behind schedule”, “completed”, etc.
“Due date”—the date/time by which the entire process represented by the flowchart should be performed.
“Date done”—a field available for the status reporting program to subsequently enter the date/time that the entire process was performed.
“Comments”—a caption or text that will appear above the flowchart which is displayed to describe the process represented by the flowchart, extra pertinent information for the flowchart, flowchart author, and contact information.
“Number of steps”—total number of steps in the flowchart.
“Step ID”—indicates a step, if any, in another flowchart, that this flowchart represents. In other words, there may be another flowchart with a step comprised of multiple substeps, and the flowchart represented by the Flowchart table represents the substeps in the step of the other flowchart. This is a foreign key field, but also optional to fill in.
   In response to the data entered in steps 100 and 104, flowchart generation program 29 generates and stores the foregoing “Flowchart” table.

In step 104, the vendor also enters information for the parameters listed in the following Step table template (with the exception of state information), for each step in the flowchart:

### Step Table Parameters and Fields

“Step ID” is a “primary key” identifier/integer for the step (which is unique within the flowchart).
“Flowchart ID” is a “foreign key” identifier/integer for the overall flowchart (which links this step to a particular flowchart. A step can exists in multiple flowcharts.
“Step name” is another identifier, in the form of a human understandable name, for the step.
“State” is the current status of the step represented by a value for the specified integer. For example, the state can be “not yet performed, but not behind schedule”, “not yet performed and behind schedule”, “already performed and on schedule”, “already performed but behind schedule”, “awaiting customer/vendor input”, etc.
“Due date” is the date/time by which the step should be performed. The status reporting program 25 can periodically check the due date/time and compare them to the current date/time to determine if the due date/time have passed. This will result in a “behind schedule” status for the step.
“Date done” is a field available for the status reporting program to subsequently enter the date/time that the step was performed.
“Comments” are the caption or text that will appear on the step icon on the flowchart which is displayed.
“Old step link” is a pointer or link to a repository that stores the data of this same table that was entered during previous iterations of the flowchart.
   In response to the data entered in steps 100 and 104, flowchart generation program 29 generates and stores the foregoing “Step” tables.

Next, the vendor defines the order of the steps, the relationship between the steps and the appearance of the steps in the flowchart when displayed (step 110). In step 110, the vendor selects an icon for each step, and defines a graphical connector between the steps. For example, the icon for each step can be a rectangle, and there can be an arrow between the rectangles indicating the order in which the steps should be performed. For example, step 62 represents a step of a service process, and arrow 63 indicates that another step 64 of the service process follows step 62. The vendor also enters the name of each graphical step to correlate the graphical icon/step to one of the Step tables where more information is stored about the step. This will cause the Comments in the Step table to appear within the icon. As explained in more detail below, this will also allow subsequent graphical update such as color-coding of each graphical step to represent the current status as written into the corresponding Step table.

The vendor can also define steps or tasks which are dependent on the occurrence of other events or conditions. For example, there can be a “decision block” typically shown as a diamond in the flow chart. The outcome of the decision can be based on whether a certain event or condition occurs. For example, the condition can be whether a help desk person received a call for support. Another condition can be whether there was a failure of a computer system that required backup. An event can be the failure of a computer system. The “yes” branch of the condition/decision block leads to one series of steps and the “no” branch of the condition/decision block leads to another series of steps.

FIG. 3 illustrates one example of such a flow chart 60 produced by flowchart generation program 29 based on the Flowchart Tables, the Step tables, and the graphical descriptions provided in step 110. In this example, flow chart 60 describes a computer integration service or contract for computer integration service. The sequential steps are installation of an operating system (step 62), test of the operating system (step 64), installation of middleware (step 66), test of middleware (step 68), installation of an application program (step 70) and test of the application program (step 72), etc. Other examples of such flowcharts are as follows. A building construction process requires clearing and leveling of land, then laying a foundation, then framing, etc. A computer security incident response process comprises the following steps. The vendor logs a problem with a computer system, then gathers preliminary information such as machine type, operating system, identity of application causing the problem, MAC address of the computer system, IP address of the computer system, etc. Then, the vendor notifies the customer via phone/email/letter/in-person. Then, the vendor gathers more detailed information such as other machines reporting similar problems, firewall configurations, detailed log analysis, etc. Then, the vendor begins to correct the problem.

Program tools such as AllClear (tm of Proquis Corporation) program are currently known to form a flow chart based on developer specification of (a) the icon for each step or decision, (b) a descriptive caption within each icon and the connectors between the icons. Next, the AllClear program places the flow chart (as a graphics file) into the web page (HTML code) so it can be sent over the Internet (step 114), and available to users via the Internet. The AllClear program implements this by creating the flowchart as a graphics file (such as JPG) and then making the graphics file available to a web page (on the server), where it is referenced. The present invention splits the steps of the flowchart JPG into separate graphic files and creates multiple colored files for every step. The present invention also augments the webpage with additional scripts to poll the database, select the correct colors of steps to represent the current status and allow the user to select a particular step for more information. In the illustrated embodiment, a customer using computer workstation 30 or a vendor employee using his or her own computer can request and view the flowchart using a known web browser such as Internet Explorer, Netscape, etc. As an alternate embodiment, flowcharts could be created manually with any graphics program. The resulting graphical file could then be posted to a website, where JavaScript, Java Server Pages (JSPs), or other language could be used to select certain objects based on a mouse position relative to location of an object on the screen.

The vendor can also use the AllClear program in step 110 to define a more detailed flowchart for any of the steps in the main flow chart. The vendor creates the more detailed flow chart in the same manner as creating the main flow chart, except that for the more detailed flow chart, the vendor also specifies the corresponding step or task in the main flow chart. This is the “Step ID” parameter in the Flowchart Table. Then, when the user “clicks on” or otherwise selects a step in the main flow chart, the user's web browser will display the more detailed flow chart, if any (step 120).

The vendor can also use a Flash (tm of Macromedia Corp.) Program, Java Server Pages, JavaScript program or other such program in step 110 to define more detailed information for any of the steps in the main flow chart. The vendor specifies the more detailed information and the corresponding step in the main flow chart. Then, when the user “clicks on” or otherwise selects a step in the main flow chart, the user's web browser will display the more detailed information, if any (step 120).

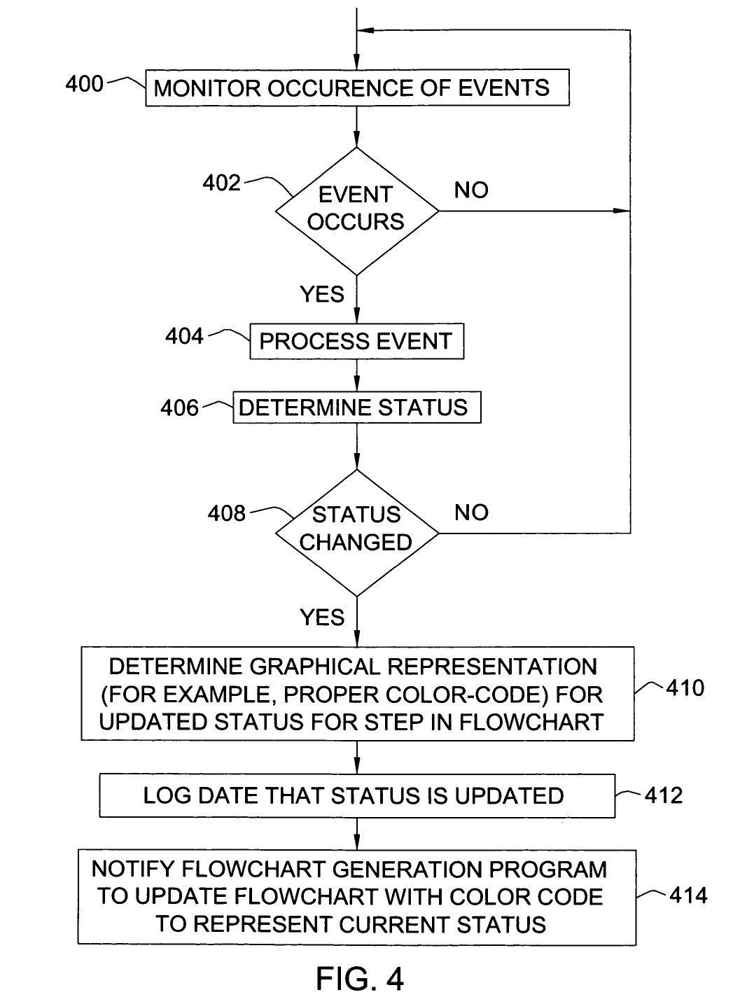

As explained in more detail below with reference to FIG. 4, during performance of the contract or process represented by the flowchart, the status reporting program 25 causes a graphical update of the flowchart to illustrate the status, allowing the customer to view problems and/or progress. At some point the contract or process ends, either when it is completed or when the vendor and/or customer terminate the contract or performance (step 124).

In accordance with the present invention, when the flow chart is enabled, the flow chart indicates the status of the contract or process by highlights, color-codes or other marking of the steps of the flow chart to represent their current status. For example, the status reporting program 25 can color-code as green every step that has been completed. The status reporting program 25 can color code as yellow any step which is any amount behind schedule or in any respect problematic. The status reporting program 25 can color code as red any step which is seriously behind schedule (more than a predetermined amount) or seriously problematic (based on predefined problems).

FIG. 4 illustrates the foregoing function of the status reporting program 25 in more detail. There are various ways that the status reporting program 25 can learn of a change in status of a step in the flowchart. For example, as each step or task is completed, a worker (typically an employee of the vendor organization) can use the status entry program 39 in computer 30 to enter the new status. In response, the status entry program 39 will notify the status reporting program 25 in computer 10. This notification is one type of “event” which the status reporting program detects in decision 400. For example, after a help desk support person solves a problem of a customer caller, the help desk support person can enter into the status entry program 39 that the problem has been solved. In response, the status entry program 39 will notify the status reporting program 25 that the problem has been solved. This entry into the status entry program 39 can be made by the worker displaying the flowchart with the worker's web browser, selecting the icon on the flow chart (such as by clicking with a right mouse button) representing the task of solving of the problem, and then entering the status of “completion on schedule” into a field displayed by the web browser in response to selection of the icon. If the worker experienced a problem, the worker can also enter the type of problem. Authentication of authorized workers can be accomplished via normal web means (such as checking cookies or intranet passwords) or by storing authorized user IDs in a database. Alternately, the status reporting program 25 can periodically read a log or file within computer 30 to which a help desk program 29 in computer 20 writes when the help desk support person enters a record indicating that the problem has been solved (or the “incident” has been closed). When there has been an update to this log or file since the last reading of this log or file, this is considered an “event” which the status reporting program 25 detects in step 400. Alternately, completion of a step of the contract performance or process represented by the flowchart may result in a state change of a variable associated with the contract performance or process. In such a case, the status reporting program 25 periodically monitors the state of this variable to determine when the state, and therefore the status of the corresponding step in the flowchart, has changed. This would also be an “event” which the status reporting program 25 detects in step 400. For those steps for which a due date/time is specified in the Step table, the status reporting program 25 periodically compares the due date/time to the current date/time to determine if the due date/time has passed without completion of the step (indicated by vendor entry, reading of log 33, reading of another log or file or noting a certain state of a variable). This missing of the due date/time is also an “event” which the status reporting program 25 detects in step 400.

In response to detection of an “event” in decision 402, yes branch, the status reporting program 25 processes the event by automatically determining the current status of the step from the user input, information in the logs or files, variable state, comparison of the due date/time to the current date/time or other source (step 404). In some cases, the status of a step in the flowchart may depend on more than one event or the status of a group of substeps. The status reporting program 25 consults its own file to determine what events or groups of substeps determine the status of each step in the flowchart. Then, the status reporting program 25 compares the current status to the status determined during the previous iteration of the steps of FIG. 4 (decision 408). If the status has changed (decision 408, yes branch), then the status reporting program 25 will determine a color-code for the respective icon, for example, green for “completed on schedule”, yellow for “behind schedule”, red for “substantially behind schedule” (step 410). The status reporting program 25 can also determine a caption to the step icon describing any problems that were encountered or other status information that cannot be readily represented by the color-code (step 410). The status reporting program 30 will also log the time/date that the step was completed (step 412). Then, the status reporting program 30 notifies the flowchart generation program 29 to modify the graphical presentation of the flow chart to display the appropriate color-code and any other caption which the status reporting program 30 determined in step 410 as appropriate (step 412). Then, the flowchart generation program 29 makes this graphical presentation available to users via the WWW (or shared network) to display the current status of the contract performance or process represented by the flowchart (step 414). The Javascript, JSP or other such code on the page sets “if” conditions that will display the different colors depending on the current status of the respective steps in the flow chart. Therefore, upon every refresh of the page, the images are dynamically generated to represent the current status of the respective steps.

The status reporting program 25 can be loaded into computer 10 from a computer storage medium 75 (for example, magnetic, optical or DVD disk or tape) or downloaded from the Internet. Likewise, the status entry program 39 can be loaded into computer 30 from a computer storage medium 77 (for example, magnetic, optical or DVD disk or tape) or downloaded from the Internet.

Based on the foregoing, a system, method and program product for reporting the status or contract completion or a manufacturing, service or business process have been disclosed. However, numerous modifications and substitutions can be made without deviating from the scope of the present invention. For example, reports can be generated in hardcopy format such as a PDF, with the same color-coding to represent the status. This allows physical copies of reports to be printed or attached to e-mails which are distributed to vendor employees and the customer. This does not require viewing with a web browser via the Internet. Therefore, the present invention has been disclosed by way of illustration and not limitation, and reference should be made to the following claims to determine the scope of the present invention.

1. A method for reporting status of a process, said method comprising the steps of:
creating a flow chart which illustrates steps of the process and an order for performance of the steps;
determining whether any of the steps has been performed; and
in response to a determination that any of the steps has been performed, graphically representing on said flow chart that said any step has been performed.

2. A method as set forth in claim 1 wherein the determining step is made by a person selecting said any step from said flow chart, and entering information that said any step has been performed.

3. A method as set forth in claim 1 wherein the determining step is made automatically by a program checking a record indicating that said any step has been performed.

4. A method as set forth in claim 1 wherein the graphically representing step comprises the step of color-coding said any step.

5. A method as set forth in claim 1 further comprising the steps of:
automatically determining that a deadline for performing one of said steps has passed without performance of said one step, and in response, graphically representing said one step in said flowchart that said deadline has passed without performance of said one step.

6. A method as set forth in claim 5 wherein the step of graphically representing that said deadline has passed without performance of said one step comprises the step of color-coding said one step in a manner to indicate a problem with said one step.

7. A method as set forth in claim 5 wherein the automatic determining step is performed by a program automatically comparing a recorded date and/or time that a step should be performed to a current date and/or time.

8. A method as set forth in claim 1 further comprising the steps of:
automatically determining that a problem has occurred in performing one of said steps, and in response, graphically representing said one step in said flowchart that a problem has occurred with said one step.

9. A method as set forth in claim 8 wherein the step of graphically representing that a problem has occurred with said one step comprises the step of color-coding said one step on said flowchart to indicate that a problem has occurred with said one step.

10. A method as set forth in claim 1 wherein said process represents obligations of a contract.

11. A method as set forth in claim 1 wherein said process represents computer related services.

12. A system for reporting status of a process, a flow chart illustrating steps of the process and an order for performance of the steps, said system comprising:
means for determining whether any of the steps has been performed; and
means, responsive to a determination that any of the steps has been performed, for graphically representing on said flow chart that said any step has been performed.

13. A system as set forth in claim 12 wherein the determining means comprises program means for checking a record indicating that said any step has been performed.

14. A system as set forth in claim 12 wherein the graphically representing means comprises means for color-coding said any step.

15. A system as set forth in claim 12 further comprising:
means for automatically determining that a deadline for performing one of said steps has passed without performance of said one step, and in response, graphically representing said one step in said flowchart that said deadline has passed without performance of said one step.

16. A system as set forth in claim 15 wherein the means for graphically representing that said deadline has passed without performance of said one step comprises means for color-coding said one step in a manner to indicate a problem with said one step.

17. A system as set forth in claim 15 further comprising:
means for automatically determining that a problem has occurred in performing one of said steps, and in response, graphically representing said one step in said flowchart that a problem has occurred with said one step.

18. A system as set forth in claim 17 wherein the means for graphically representing that a problem has occurred with said one step comprises means for color-coding said one step on said flowchart to indicate that a problem has occurred with said one step.

19. A computer program product for reporting status of a process, a flow chart illustrating steps of the process and an order for performance of the steps, said computer program product comprising:
a computer readable medium;
first program instructions to determine whether any of the steps has been performed; and
second program instructions, responsive to a determination that any of the steps has been performed, to graphically represent on said flow chart that said any step has been performed; and wherein
said first and second program instructions are stored on said medium.

20. A computer program product as set forth in claim 19, further comprising:
third program instructions to automatically determine whether or not said any step has been performed; and wherein said third program instructions are recorded on said medium.
